(19) United States
(12) Patent Application Publication
(10) Pub. No.: US 2002/0069158 A1
(43) Pub. Date: Jun. 6, 2002

(54) Method and system for providing a secured multi-purpose electronic account

(76) Inventors: Cameron J. Larkin, New York, NY (US); Steven D. Copertino, Hillsdale, NJ (US); Michael G. Bucheit, New York, NY (US); Allan T. Schwedock, Norwalk, CT (US); Kevin D. Leitao, New Canaan, CT (US); Geoffrey B. Wilson, New Fairfield, CT (US)

Correspondence Address: CANTOR COLBURN, LLP, 55 GRIFFIN ROAD SOUTH, BLOOMFIELD, CT, 06002

(21) Appl. No.: 09/727,883

(22) Filed: Dec. 1, 2000

(51) Int. Cl. G06F 17/60

(52) U.S. Cl. 705/38; 705/35

(57) ABSTRACT

An exemplary embodiment of the invention is a method for providing online commerce. The method includes receiving a request for credit functionality from a customer and establishing credit account if the customer meets credit worthiness requirements of a credit provider. An account identifier is associated with the credit account. The method also includes receiving a request for debit functionality that includes debit source information. The debit worthiness of the debit source is verified and the account identifier is associated with the debit source.

### BACKGROUND OF THE INVENTION

The present invention relates to a method and system for online purchasing of goods and services. More specifically, the present invention relates to the purchasing of goods and services online using a multi-purpose account providing both credit and debit functionality.

Online commerce is experiencing dramatic growth in recent years. More merchants are developing sites on the World Wide Web (or simply “WWW” or “Web”) that consumers can access and order goods and/or services. It is fairly common for a consumer to browse a merchant's catalog, select a product, place an order for the product, and pay for the product all electronically over the Internet. Typically, the consumer pays for the goods and/or services ordered over the Internet with a credit card. During the online transaction, the customer selects goods and/or services that the customer wishes to purchase. The customer goes to the merchant's checkout page and selects a payment method and inputs requested personal data (e.g., name, address, and telephone number) and credit card information (e.g., account number and expiration date) and selects a “buy” button. The merchant verifies that the credit card number is valid and can be charged the payment amount. The card verification is usually conducted on a well-established card network.

A concern is that a new online commerce model should integrate well with existing proprietary card network systems. There are well-established systems that verify credit card purchases and subsequently settle accounts. However, existing online systems are not equipped to handle debit type transactions available with debit cards. Thus, there is a need in the art for providing debit functionality in online purchasing systems.

### SUMMARY OF THE INVENTION

An exemplary embodiment of the invention is a method for providing online commerce. The method includes receiving a request for credit functionality from a customer and establishing credit account if the customer meets credit worthiness requirements of a credit provider. An account identifier is associated with the credit account. The method also includes receiving a request for debit functionality that includes debit source information. The debit worthiness of the debit source is verified and the account identifier is associated with the debit source.

### BRIEF DESCRIPTION OF THE DRAWINGS

Referring now to the drawings wherein like elements are numbered alike in several FIGURES:

FIG. 1 depicts the interconnection of various computers in an electronic purchasing system;

FIG. 2 depicts an exemplary checkout user interface;

FIG. 3 depicts a pictorial flow of an electronic account acquisition; and

FIG. 4 depicts a pictorial flow of an online purchase.

### DETAILED DESCRIPTION OF THE INVENTION

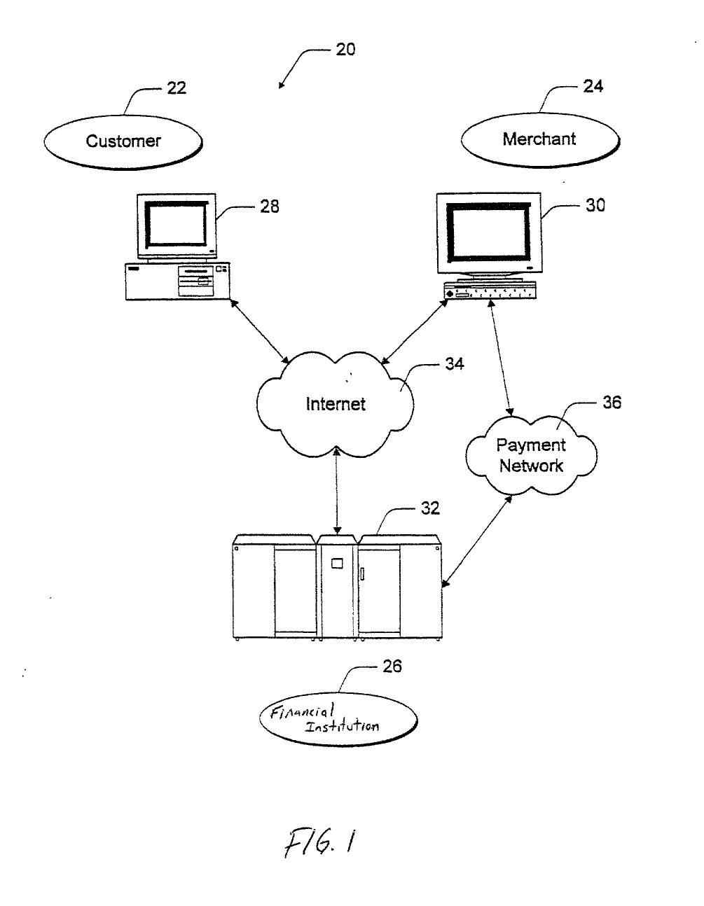

FIG. 1 shows an online commerce system 20 for conducting online commerce transactions. For general discussion purposes, three participants to an online commerce transaction are shown: a customer 22, a merchant 24, and a financial institution 26. These three participants play the primary roles in the online commerce transaction. The customer and merchant may represent individual people, entities, or businesses. The financial institution 26 may represent a debit source (e.g., a bank) or a credit provider such as a credit card company, card sponsoring company, or third party issuer under contract with financial institutions. It is further noted that other participants may be involved in some phases of the transaction, such as an intermediary settlement institution, but these participants are not shown.

Each participant is equipped with a computing system to facilitate online commerce transactions. The customer 22 has a customer system 28 in the form of a personal computer, although other types of computing units may be used including laptops, notebooks, handheld computers, set-top boxes, and the like. The merchant 24 has a merchant system 30 implemented in the form of a computer server, although other implementations are possible. The financial institution 26 has a computing center 32 shown as a mainframe computer. However, the financial institution computing center 32 may be implemented in other forms, such as a minicomputer, a PC server, a networked set of computers, and the like. The customer system 28 executes a computer program (e.g., web browser) to contact a merchant system 30. The merchant system 30 also executes a computer program for interacting with the customer system 28 and a payment network 36.

The customer system 28, merchant system 30 and computing center 32 are connected with each other via a data communication network 34. The network 34 is a public network and assumed to be insecure and open to eavesdroppers. In the illustrated implementation, the network 34 is embodied as the Internet. In this context, the computers may or may not be connected to the network 34 at all times. For instance, the customer system 28 may employ a modem to occasionally connect to the Internet 34, whereas the financial institution computing center 32 may maintain a permanent connection to the network 34. It is noted that the network 34 may be implemented as other types of networks, such as an interactive television (ITV) network.

The merchant system 30 and the financial institution computing center 32 are interconnected via a second network, referred to as a payment network 36. The payment network 36 represents existing proprietary networks that presently accommodate transactions for credit cards, debit cards, and other types of financial/banking cards. The payment network 36 is closed network that is assumed to be secure from eavesdroppers. Examples of the payment network 36 include the Paymentech network and the First Data network.

In the preferred implementation, the electronic commerce system 20 is implemented through computer software programs executed by the customer system 28 and/or the financial institution computing center 32. An advantage of the invention is that the merchant system 30 does not require any additional software to participate in the online commerce transaction supported by the online commerce system 20. The merchant system 30 interfaces with a payment processor, described in further detail herein, which handles the credit and debit functionality. Thus, the merchant system 30 does not require any additional functionality to participate in the system.

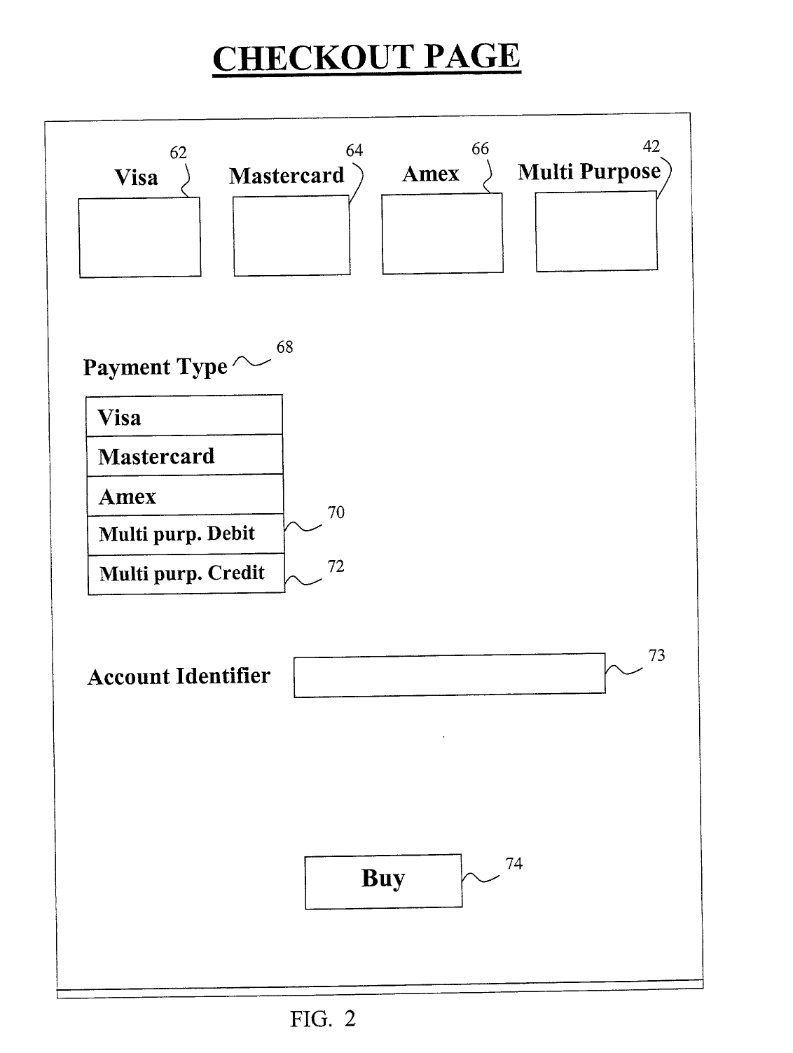

An exemplary method of purchasing of goods and services online includes connecting a customer system 28 to a merchant web page via the network 34 where the customer selects one or more goods or services to be purchased from the online merchant. The customer then proceeds to a checkout page as known in the art. An example checkout user interface is shown in FIG. 2. As shown in FIG. 2, the checkout user interface includes a number of icons 62, 64, 66 and 42 corresponding to different types of payment methods accepted by the merchant. One such accepted payment method is labeled multi-purpose, which is the payment program of the present invention.

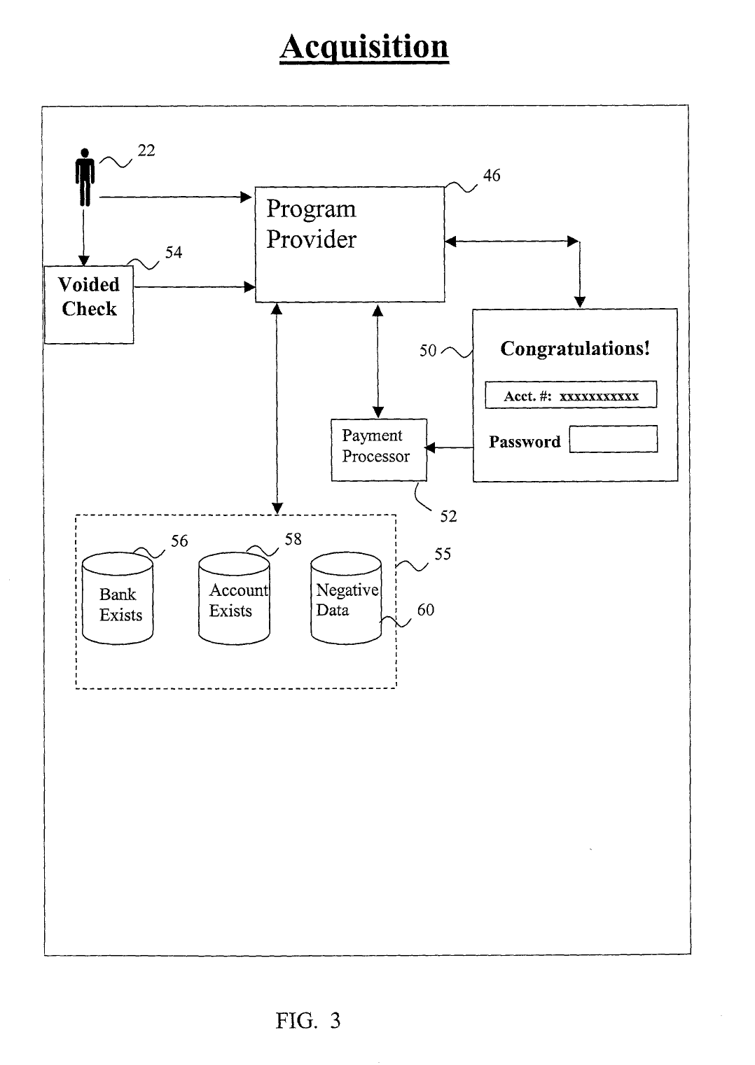

To utilize the multi-purpose payment program, the customer must establish a multi-purpose account. FIG. 3 is pictorial flow diagram of the account acquisition process for the multi-purpose payment option. The customer 22 is directed to a web page of an entity offering the multi-purpose program. This entity is referred to as the multi-purpose program provider 46. Through credit application web pages, the customer 22 will be asked for personal data and credit card data to determine credit worthiness for a multi-purpose credit account. In a preferred embodiment, the multipurpose program provider 46 is a credit provider such as an issuer of a credit card. The multi-purpose program provider 46 accesses the credit worthiness of the customer 22 using normal credit verification techniques including a bureau check. If customer 22 has been approved for credit, the customer is sent an approval notification 50 at the customer system 28 with an account number and a request for customer 22 to input a password. The account identifier (e.g., account number and password), customer information and credit provider information is forwarded to a payment processor 52 such as PaymenTech. This data can now be used for purchases of goods and services from any merchant that uses the multi-purpose payment system. The customer is similarly notified if credit is denied. In some states, the credit application information from the multi-purpose program provider 46 must be sent by mail. In that case, the customer may print the application form and send it to the multi-purpose program provider by mail. The customer can then be notified of credit approval and select a password electronically as described above.

In enrolling in the multi-purpose payment program, the customer 22 is additionally notified through the multi-purpose program provider 46 web page that the customer may have debit functionality by sending a voided check 54 from his/her checking account to the program provider. The multi-purpose program provider 46 uses the ABA data on the voided check to verify the account status. Instead of sending a voided check, the customer can submit the ABA routing number and checking account number by some other means (e.g., an online form). The multipurpose program provider 46 queries negative databases 55 associated with debit sources (e.g., banks) to verify debit worthiness. The databases 55 are referred to as negative databases because they contain information indicative of negative account activity such as over drawn accounts, etc. A first negative database 54 is used to confirm that the customer bank exists. A second negative database 58 is used to verify that the checking account exists. A third negative database 60 is used to verify that no negative data about the account holder exists, such as bounced checks. If none of these databases reports any negative results, program provider 46 notifies the payment processor 52 that the customer is approved for debit functionality. The program provider 46 provides the customer account identifier, including account number and password, and the customer's debit source (e.g., bank checking account) to payment processor 52.

The customer 22 may obtain one or both of credit functionality and debit functionality in the multi-purpose program. In a preferred embodiment, customers who are not approved for credit functionality may be automatically refused debit functionality. There is usually a time frame of 7-10 days when the customer's credit account is approved, but the debit functionality is not complete because the customer's voided check 54 has not been received and processed. If the customer has an approved credit account but lacks debit functionality he/she may purchase a product or service so long as the purchase is within his/her available credit line.

Once customer 22 has received multi-purpose credit and/or debit functionality approval, he/she can order goods or services online. When customer 22 has selected goods or services for purchase, the customer is directed to a checkout web page as shown in FIG. 2. The customer is given a choice of several payment techniques, such as Visa® 62, MasterCard®64 American Express® 66, or the multi-purpose payment option 42. The payment type may be selected by a pull-down menu 68. The multi-purpose options may be presented in two parts, credit 70 and debit 72. Once the customer indicates the payment type, the customer inputs an account identifier in account identifier field 73. In the case of the multi-purpose program, the account identifier includes an account number and a password. Once the customer has inputted the payment choice and the appropriate account identifier, the customer is prompted to select the “Buy” icon 74.

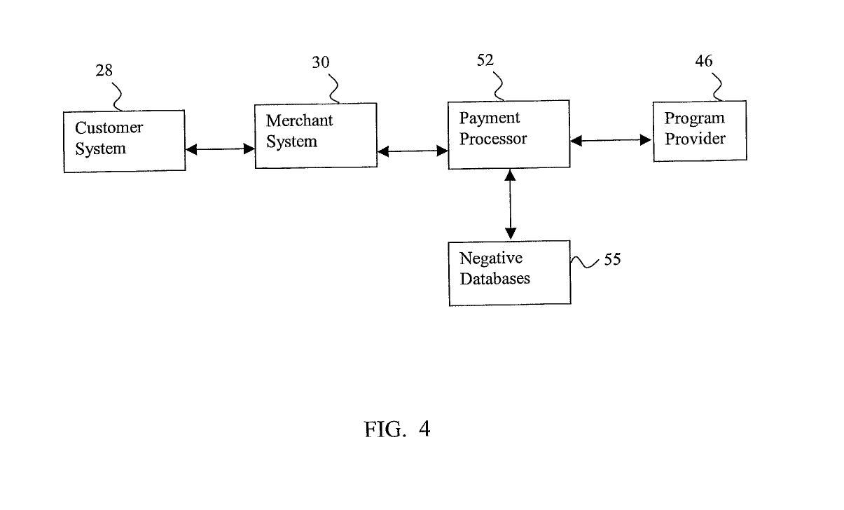

If either the multi-purpose credit option 70 or multi-purpose debit option 72 has been selected, a buy process as shown in FIG. 4 is performed. As shown in FIG. 4, the customer system 28 has interacted with a merchant system 30 to initiate purchase of goods or services. The merchant system 30 contacts payment processor 52 and provides the customer account identifier, the type of purchase (credit or debit) and purchase amount. If the purchase is a credit purchase, the payment processor 52 contacts multi-purpose program provider 46 to determine whether the customer's credit level is sufficient. If the multi-purpose program provider 46 approves the credit purchase, payment processor 52 notifies the merchant system 30. The customer system 28 is notified that the transaction has been approved and may be given a confirmation number. The multi-purpose program provider 46 charges the customer's charge account. The merchant is authorized to ship the goods or provide the services selected by the customer.

If the purchase is a debit purchase, the payment processor 52 accesses negative databases 55 to determine debit worthiness. If the negative databases 55 indicates that the customer is debit worthy, payment processor 52 notifies the merchant system 30. The customer system 28 is notified that the transaction has been approved and may be given a confirmation number. The merchant is authorized to ship the goods or provide the services selected by the customer. Using a payment processor 52 as an intermediary between the merchant and the multi-purpose program provider 46 and the negative databases 55 renders the payment program transparent to merchant system 30. The merchant system 30 does not need to directly interface with systems of the multi-purpose program provider 46 or the negative databases 55.

In a preferred embodiment, the multi-purpose program provider is the same entity as the credit provider. Thus, the debit functionality is another service offered by the provider of a credit instrument such as a credit card. In settling accounts, the merchant system 30 submits the payment processor 52 a statement of all purchases, both debit and credit. The multi-purpose program provider 46 provides payment to the merchant through payment processor 52. The payment processor 52 also transfers funds from the debit source (customer's bank) to the merchant's bank. A portion of the sales amount goes to payment processor 52. In addition, for debit transactions, a portion of the sales amount (e.g., 0.5-3%) is provided to the multi-purpose program provider 46 which in one embodiment is the credit provider. In this manner, the credit provider earns income by offering the credit/debit functionality. The multipurpose program provider 46 may be a different entity than the credit provider and interact with the credit provider to determine credit worthiness and approve credit transactions.

In an alternate embodiment of the invention, the payment processor 52 directly accesses the customer's debit source (e.g., customer's bank) to determine if the customer has sufficient funds to allow the transaction. Such operation is similar to what occurs with existing debit cards. In the above-described embodiment, the system provides debit functionality by checking negative databases 55, but does not confirm the existence of funds in the debit source. Use of a conventional bank “debit” card directly debits the checking account of the user of the debit card. The “debit” card bank will authorize a purchase only if there are sufficient funds in the user's checking account. However, in a preferred embodiment of the multi-purpose payment program, the system authorizes the payment to the merchant if there is no “negative” information in the negative databases. This is attractive to consumers because they can obtain debit functionality while maintaining their existing checking account. There is no need for the consumer to open a new checking account (which consumers are reluctant to do) because debit worthiness is based on the negative databases. This also provides security in that the program provider does not have to access the consumer's bank account to provide debit functionality. The program provider may have access to consumer's bank account for certain types of transactions. There is some inherent risk in authorizing the debiting of the checking account without knowledge of the funds status. To reduce this risk, the credit provider can charge the customer's charge account for any funds not received through the debit functionality process plus fees for the inconvenience and loss of revenue.

Another feature of the multi-purpose payment system that aids in the security of Internet transactions is the use of unique account identifier with a limited number of digits in the account number and a separate password. Existing online merchants typically prompt the consumer to enter a credit card number. Thus, the merchant uses a one-stage routine for credit card number entry. To provide debit functionality with existing debit cards, a PIN must be entered. Accordingly, merchants will have to modify existing one-stage routines to enable two-stage entries (first account number, then PIN).

The account identifier of the present invention eliminates the need for merchants to modify existing, one-stage routines. The account identifier of the present invention includes an account number and password, the total length of which is commensurate with existing credit card number lengths. Thus, the consumer can enter the account number and password in a single stage, with the account identifier fitting the current account identifier entry field on merchant checkout pages. An exemplary account number has 11 digits and an exemplary password has 4 digits. However, the account number and password may vary by the issuer of the multipurpose payment system. In an exemplary embodiment, the account number ranges from 5 to 15 digits and the password ranges from 1 to 10 digits. At the time the application for a credit account is approved by a multi-purpose program provider 46, an account number is assigned to the customer 22. The customer 22 is also assigned or allowed to choose a password whose number of digits plus the number of digits in the account number form an account identifier used for purchases. At the time a retail sales transaction is made, the customer 22 is instructed to enter both the account number and password as one continuous sequence of characters. The merchant system 30 passes the entire sequence of digits to the payment processor 52 without knowledge of whether a password is involved. The multi-purpose program provider 46 can then validate the password against the account number in its own security files as part of the transaction authorization process. Only the account number is displayed on statements, servicing letters, embossed plastic, credit bureau reports and other customer related documents to help protect the integrity of the password. The password is never displayed or seen on any of these documents.

The customer 22 may be issued a multi-purpose identification card that looks like a typical credit card but in this example it has only 11 digits. The card is nonfunctional (e.g., lacks magnetic stripe) and is used to indicate membership in the multi-purpose payment program. The customer 22 has the option of changing the password by notifying the credit provider of his/her desire to do so using standard security features of the financial industry.

Another feature of the multi-purpose account is the use of cash rewards as an incentive to the customer to use the multi-purpose account. Cash rewards are commonly available in the credit card industry. The rewards in this embodiment have two features. The first is the availability of rewards for the combination of credit purchases and purchases using the debit functionality. The second is the use of tiered levels of rewards. An exemplary embodiment has a reward level of 0.25% of the first $100 dollars of purchases during a billing month, a reward level of 0.5% for net purchases greater than $100 to $200 in a billing month, a reward level of 0.75% for net purchases greater than $200 to $300 in a billing month and a reward level of 1.0% for net purchases greater than $300 in a billing month. These levels are exemplary and can be varied in reward level and/or purchasing level by the credit provider.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the present invention has been described in terms of specific embodiments, it should be understood that these embodiments are illustrative and should not be taken as limiting. The scope of the invention should be limited only in accordance with the following claims.

What is claimed is:

1. A method for providing online commerce comprising:
receiving a request for credit functionality from a customer;
establishing a credit account if said customer meets credit worthiness requirements of a credit provider;
generating an account identifier associated with said credit account;
receiving a request for debit functionality, said request for debit functionality including debit source information;
verifying debit worthiness of said debit source; and
establishing debit functionality for the customer and associating said account identifier with said debit source.

2. The method of claim 1 wherein said debit worthiness is determined by accessing at least one negative database.

3. The method of claim 1 wherein said debit worthiness is determined by accessing an account balance through said debit source.

4. The method of claim 1 wherein said debit source information is a customer check.

5. The method of claim 1 further comprising refusing to establish debit functionality if credit worthiness is lacking.

6. The method of claim 1 further comprising:
receiving a purchase request from said customer, said purchase request including said account identifier, a purchase amount and a payment type;
if said payment type is credit, comparing said purchase amount to an available credit line associated with said account identifier and authorizing said purchase if said purchase amount is less than said available credit line; and
if said payment type is debit, determining debit worthiness by accessing at least one negative database and authorizing said purchase if said at least one negative database lacks said account identifier.

7. The method of claim 1 further comprising:
receiving a purchase request from said customer, said purchase request including said account identifier, a purchase amount and a payment type;
if said payment type is credit, comparing said purchase amount to an available credit line associated with said account identifier and authorizing said purchase if said purchase amount is less than said available credit line; and
if said payment type is debit, comparing said purchase amount to a debit balance associated with said account identifier and authorizing said purchase if said purchase amount is less than said debit balance.

8. The method of claim 1 wherein said account identifier includes an account number and a password.

9. The method of claim 8 wherein said account number has 5 to 15 digits and said password has 1 to 10 digits.

10. The method of claim 8 wherein said customer submits said account number and password as a continuous sequence of characters.

11. The method of claim 10 wherein said account identifier fits in an account identifier entry field on a merchant checkout page.

12. The method of claim 6 further comprising:
awarding said customer a reward based on purchases.

13. The method of claim 12 wherein:
said reward is based on a summation of credit purchases and debit purchases.

14. The method of claim 12 wherein a value of said reward is tiered based on an accumulated purchase amount over a predetermined period.

15. The method of claim 7 further comprising:
awarding said customer a reward based on purchases.

16. The method of claim 15 wherein:
said reward is based on a summation of credit purchases and debit purchases.

17. The method of claim 15 wherein a value of said reward is tiered based on an accumulated purchase amount over a predetermined period.

18. A method of performing online commerce comprising:
assigning a consumer an account identifier, said account identifier including an account number and a password.
receiving a request from the consumer to perform an online transaction;
prompting the consumer to enter said account identifier in a single step; and
authorizing said online transaction in response to said account identifier.

19. The method of claim 18 wherein said consumer submits said account number and password as a continuous sequence of characters.

20. The method claim 19 wherein said characters are digits.

21. The method of claim 18 wherein said account number has 5 to 15 digits and said password has 1 to 10 digits.

22. The method of claim 18 wherein said account identifier fits in an account identifier entry field on a merchant checkout page.
